(19) United States
(12) Patent Application Publication
(10) Pub. No.: US 2024/0309562 A1
(43) Pub. Date: Sep. 19, 2024

(54) CARBON FIBRE MANUFACTURING

(71) Applicant: Deakin University, Geelong, Victoria (AU)

(72) Inventors: Srinivas NUNNA, Werribee, Victoria (AU); Russell VARLEY, Camberwell, Victoria (AU); Jens HOFER, Cologne (DE); Claudia CREIGHTON, Highton, Victoria (AU); Minoo NAEBE, Highton, Victoria (AU)

(21) Appl. No.: 18/574,862

(22) PCT Filed: Jul. 8, 2022
(86) PCT No.: PCT/AU2022/050717

§ 371 Date: Dec. 28, 2023

(30) Foreign Application Priority Data
Jul. 9, 2021 (AU) 2021902103

(51) Int. Cl. D01F 9/22; C08F 20/44

(52) U.S. Cl. CPC D01F 9/225; C08F 20/44

(57) ABSTRACT

Method of identifying stabilisation conditions for producing a thermally stabilised polyacrylonitrile (PAN) based carbon fibre precursor from any batch of precursor for use in carbon fibre manufacturing process are useful for reducing cost of carbon fibre manufacture. Method of manufacturing carbon fibres, comprising the steps of: providing a batch of isothermally stabilised polyacrylonitrile (PAN) based precursor fibres which presents as absent of evidence of tow burning or tow breakage, and having a structural conversion index selected from the range of from 0.5 to 0.7; subjecting the provided batch of isothermally treated precursor fibres to a carbonisation process to produce carbon fibre.

### TECHNICAL FIELD

The invention relates to improvements in PAN based carbon fibre precursor thermal oxidative stabilisation methods in air, which lead to a reduction in the time required for PAN based carbon fibre precursors stabilisation.

### BACKGROUND

Carbon fibres have desirable mechanical properties. Carbon fibres can be roughly classified into ultra high modulus (>500 GPa), high modulus (>300 GPa), intermediate modulus (>200 GPa), low modulus (100 GPa), and high strength (>4 GPa) carbon fibres.

Carbon fibres can also be classified, based on final heat treatment temperatures, into Type I (2,000° C. heat treatment), Type II (1,500° C. heat treatment), and Type III (1,000° C. heat treatment). Type II PAN carbon fibres are usually high strength carbon fibres, while most of the high modulus carbon fibres belong to Type I.

The structure and properties of carbon fibres strongly depend on the evolution of fibre structure during the heat stabilisation process applied to a PAN based precursor. Moreover, structural transformations in fibres during this process makes them flame resistant and allow them to withstand high temperatures during carbonisation. Hence, thermal stabilisation is considered an important step in carbon fibre manufacturing.

The process of manufacturing carbon fibres from PAN based precursor fibres involves subjecting the precursor fibres to a number of processing stages including thermal stabilisation/oxidation in an air atmosphere, followed by a carbonisation stage involving initial low-temperature carbonisation which progresses to high-temperature carbonisation.

Of these stages, the initial thermal stabilisation of the PAN based precursor fibres is an important step in the entire carbon fibre manufacturing process involving PAN based precursor fibres.

The thermal stabilisation of PAN precursors involves various exothermic reactions and the formation of a polymeric ladder type structure (see FIG. 1) which ultimately transforms into a turbostratic graphitic structure during the carbonisation stage of the carbon fibre manufacture process.

During thermal stabilisation, PAN based precursor fibres undergo various structural transformations arising from progress of reactions such as cyclisation, dehydrogenation and oxidation (see FIG. 1). Cyclisation reaction leads to the formation of a closed ring structure, while dehydrogenation reaction assists in the formation of double bonds between carbon atoms with the elimination of hydrogen in the form of H₂O (i.e., water) and H₂ (i.e., hydrogen gas). Finally, oxidation reactions result in the formation of C═O (carbonyl) functional groups on the polymeric ladder type structure. Together, these structural changes increase the fibre density and render the PAN based precursor fibres thermally stable against the high temperatures applied during the subsequent carbonisation processing step.

The cyclisation and oxidation reactions which occur during the stabilisation process are exothermic in nature. Hence, if the process parameters such as temperature, time and tension are not balanced, excess heating can result in processability drawbacks (e.g., burning or breakage of fibres tows), thereby leading to downtime during the manufacturing process which leads to additional incurred costs.

In a typical oxidation process of a commercial carbon fibre manufacturing process, stabilisation of PAN based precursor fibres is performed gradually through exposure of the PAN based precursor fibres to a gradient of increasing temperatures in successive multiple stabilisation ovens (typically 4 to 8 ovens or more) in a continuous process (see FIG. 2). The stabilisation ovens are maintained at increasing temperature steps and utilise zone-specific processing parameters such as dwell time and tow tension to assure the smooth and controlled structural transformation of the PAN based precursor fibres into thermally stable fibres which are ready for carbonisation processing.

However, considering the time typically required to stabilise the fibres (i.e., approximately 50 minutes) and associated energy consumption, the conventional multi-stage PAN based precursor fibre stabilisation process is one of the reasons for the high costs associated with carbon fibre manufacture. Hence, in-depth understanding of this processing stage and identification of opportunities to reduce the cost of carbon fibres are key to improve their widespread use in the mass market (both automotive, aerospace) and renewable energy, structural applications.

Given the expensive and energy consuming nature of current stabilisation processing during the manufacture of PAN-based carbon fibres, provision of rapid, more cost-effective method for PAN based precursor fibres stabilisation is an important improvement and a key step to creating low-cost carbon fibres.

### STATEMENT OF THE INVENTION

In a first aspect, the invention provides a method of identifying stabilisation conditions for producing a thermally stabilised polyacrylonitrile (PAN) based carbon fibre precursor from any batch of precursor for use in a carbon fibre manufacturing process, the method comprising:
(A): thermally stabilising a sample tow from a particular batch of polyacrylonitrile (PAN) based precursor fibres under investigation by:
(i) subjecting the sample tow to a first set of stabilisation conditions by applying a single isothermal heating treatment to the sample tow at a first temperature (Tₓ¹) selected from about 200° C. to about 300° C. for a treatment time (P_{z}¹) of 30 minutes or less, thereby producing an isothermally treated precursor sample tow,
(ii) assessing if Tₓ¹ and P_{z}¹ are optimal stabilisation conditions for the sample tow by examining the isothermally treated precursor sample tow for absence or presence of evidence of tow burning or tow breakage, and
   whereby:
identifying of such evidence indicates that Tₓ¹ and P_{z}¹ are not optimal for the treated precursor sample tow and the isothermally treated precursor sample tow produced is unsuitable to withstand a subsequent carbonisation step required to generate a carbon fibre; and whereby:
in absence of such evidence, the method comprises the further step of:
(B): determining a structural conversion index (SCI) associated with the isothermally treated precursor sample tow by
obtaining a Fourier Transform Infrared Spectroscopy (FTIR) spectrum of the isothermally treated precursor sample tow, and
calculating the SCI using the following equation:

$$Conversion index = \frac{0.29 \times Abs ( 1595 )}{Abs ( 2243 ) + 0.29 \times Abs ( 1595 )}$$

wherein,
   Abs(1595) is the absorbance peak intensity at 1595 cm⁻¹ wavenumber which corresponds to C═N functional group, and
   Abs(2243) is the absorbance peak intensity at 2243 cm⁻¹ wavenumber which is associated with C≡N functional group,
      whereby,
determining an SCI of less than 0.5 indicates that the isothermally treated precursor sample tow is not sufficiently thermally stabilised to withstand a subsequent carbonisation treatment step to generate a carbon fibre,
or
determining an SCI of from 0.5 to 0.7 indicates that the isothermally treated precursor sample tow is sufficiently stabilised to withstand a subsequent carbonisation treatment to generate a carbon fibre.

It will be understood that the term “generating a carbon fibre” also covers “generating carbon fibre”, that is more than one carbon fibre, such as were a plurality of tows are subjected to the methods described herein.

In a second aspect, the invention provides a carbon fibre manufacturing method involving precursor stabilising conditions identified by the method of the first aspect.

In a third aspect, the invention provides a method of manufacturing carbon fibres, comprising the steps of:
subjecting a batch of polyacrylonitrile (PAN) based precursor fibres to stabilisation conditions for that batch of precursor fibres as identified by a method of the first aspect, thereby generating a batch of isothermally treated precursor fibres;
subjecting the batch of isothermally treated precursor fibres to a carbonisation process to produce carbon fibres.

In a fourth aspect, the invention provides carbon fibres obtainable by or obtained by the method of the second or third aspect of the invention.

In a fifth aspect, the invention provides a use of a thermally stabilised polyacrylonitrile (PAN) based carbon fibre precursor of the fourth aspect in carbon fibre manufacture.

In a sixth aspect, the invention provides use of carbon fibres according to the fifth aspect in an application in the field of automotive, aerospace, sports, nuclear technology, renewable energy and/or chemical engineering fields.

### BRIEF DESCRIPTION OF THE FIGURES

Embodiments of the invention will herein be illustrated by way of example only with reference to the accompanying drawings in which:

FIG. 1 illustrates the widely accepted mechanism for the evolution of ladder polymer structure in thermally stabilised PAN fibres (Source: Rahaman, M.S.A., A.F. Ismail, and A. Mustafa, A review of heat treatment on polyacrylonitrile fiber. Polymer Degradation and Stability, 2007. 92(8): p. 1421-1432;

FIG. 2 illustrates one example of a carbon fibre research scale continuous line (Source: Nunna, S., et al., A Pathway to Reduce Energy Consumption in the Thermal Stabilization Process of Carbon Fiber Production. Energies, 2018. 11: p. 1145 (1-10)); and

FIG. 3 illustrates the relationship between the stabilisation temperature and conversion index of a) Inhouse precursor fibre-1, b) Inhouse precursor fibre-2. (Note: 24 min dwell time was used at each temperature step) and c) commercial precursor fibre-2 (Note: dwell time used for this study was 12 min).

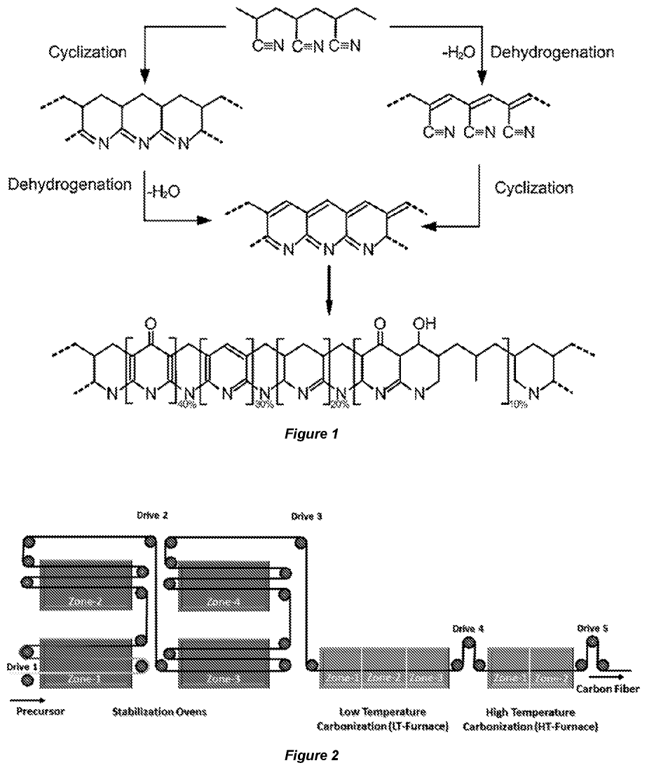

### DETAILED DESCRIPTION OF THE INVENTION

The present invention relates to improved methods of manufacture of PAN-based carbon fibres, which are faster and more cost-effective that current/conventional methods of PAN-based carbon fibre manufacture which rely on processing stages involving thermal stabilisation/oxidation of carbon fibre precursors in an air atmosphere, followed by carbonisation involving initial low-temperature carbonisation which progresses to high-temperature carbonisation in an inert atmosphere, commonly N₂.

In particular, the invention provides an improved method of thermal stabilisation (e.g., via oxidation) of suitable carbon fibre precursors which is much faster and more cost-effective that existing carbon fibre precursor thermal stabilisation methods which have been to date involved slow stabilisation times.

In a related aspect, the invention provides a means for identifying optimal thermal stabilisation processing conditions for any particular batch of polyacrylonitrile (PAN) based precursor fibres available.

Thus, the invention further provides a method of providing thermally stabilised polyacrylonitrile (PAN) based carbon fibre precursor capable of withstanding temperatures applied in a subsequent carbonisation treatment step in a carbon fibre manufacturing process to generate a carbon fibre.

The invention extends to thermally stabilised polyacrylonitrile (PAN) based carbon fibre precursor obtained by the methods of the first aspect, which are absent of evidence of tow burning or tow breakage, and have a structural conversion index selected from the range of from 0.5 to 0.7, more preferably from 0.60 to 0.65.

The invention further extends to a method of manufacturing carbon fibres, comprising the steps of:
providing a batch of isothermally stabilised polyacrylonitrile (PAN) based precursor fibres which presents as absent of evidence of tow burning or tow breakage, and having a structural conversion index selected from the range of from 0.5 to 0.7, more preferably from 0.60 to 0.65;
subjecting the provided batch of isothermally treated precursor fibres to a carbonisation process to produce carbon fibres.

The invention extends to a method of manufacturing carbon fibres, comprising the steps of:
subjecting a batch of polyacrylonitrile (PAN) based precursor fibres to precursor stabilisation conditions for that batch of precursor fibres identified as optimal for that batch by a applying method as defined in the first aspect to a sample tow of the precursor fibres from the batch, thereby generating a batch of isothermally treated precursor fibres which presents as absent of evidence of tow burning 10 or tow breakage, and having a structural conversion index selected from the range of from 0.60 to 0.65;
subjecting the batch of isothermally treated precursor fibres to a carbonisation process to produce carbon fibres.

The thermally stabilised polyacrylonitrile (PAN) based carbon fibre precursor of any given batch of polyacrylonitrile (PAN) based precursor fibres are subjected to a tailored or “personalised” thermal stabilisation process that can be applied to any particular PAN precursor starting material. An optimised thermal stabilisation step involves application of a single isothermal heat treatment step to a precursor, where the treatment is particularly devised or tailored for the particular batch of polyacrylonitrile (PAN) based precursor fibres under consideration. In some cases, the thermal stabilisation step may further involve controlling the particular time period for which the isothermal heating step is applied. The optimal thermal stabilisation step may further involve applying a particular tension to the PAN precursor fibres during processing. When correctly thermally stabilised, resultant isothermally treated precursor fibres have been optimised for a subsequent carbonisation step to generate a carbon fibre.

Desirably, the polyacrylonitrile (PAN) based precursor fibres are pristine polyacrylonitrile (PAN) based precursor fibres. Polyacrylonitrile (PAN) based precursor fibres extends to precursor fibres which include but are not limited to: a homopolymer of acrylonitrile monomers (irrespective of tacticity or molecular weight); a copolymer comprising acrylonitrile monomers; or a composition comprising at least one of these substances. For example, a precursor comprising acrylonitrile, methylacrylate and itaconic acid would be included in the types of polyacrylonitrile (PAN) based precursor fibres mentioned herein

An important part of the invention is identifying the optimal parameters of the isothermal heating treatment step carried out on any given batch of polyacrylonitrile (PAN) based precursor fibres which makes them suitable for the subsequent carbonisation step. That means the parameters that put the particular polyacrylonitrile (PAN) based precursor fibres in a more idea conditions for withstanding the subsequent carbonisation step. The particularly optimal isothermal heat treatment parameters identified are specific to a given batch of polyacrylonitrile (PAN) based precursor fibres. As well as the temperature applied, the dwell time at that temperature and/or fibre tension may also be important in some embodiments. This invention provides a simple test method which can be quickly and conveniently applied to a sample (a single tow or a few tows) of precursor fibres from a particular batch under investigation. Where the sample from the batch meets the criteria defined herein in terms of reaching optimal thermal stabilisation, this indicates that the sample have been optimised for a subsequent carbonisation step to generate a carbon fibre.

The invention provides a simple test method which can be quickly and conveniently applied to a sample (a tow or a few tows) of precursor fibres from a particular batch under investigation. Where the sample from the batch meets the criteria defined herein in terms of reaching optimal thermal stabilisation, this indicates that the sample have been optimised stabilised rendering them suitable for a subsequent carbonisation step to generate a carbon fibre. The initial tests may be conveniently carried out in a laboratory oven or the like. It follows that the so identified isothermal heat treatment parameters can then be applied on a larger scale (e.g., pilot line and/or commercial manufacturing line) to the particular precursor batch from which test sample originates.

Thus, the invention relates to a method of identifying stabilisation conditions for producing a thermally stabilised polyacrylonitrile (PAN) based carbon fibre precursor from any batch of precursor for use in a carbon fibre manufacturing process, the method comprising:
(A): thermally stabilising a sample tow from a particular batch of polyacrylonitrile (PAN) based precursor fibres under investigation by:
(i) subjecting the sample tow to a first set of stabilisation conditions by applying a single isothermal heating treatment to the sample tow at a first temperature (Tₓ¹) selected from about 200° C. to about 300° C. for a treatment time (P_{z}¹) of 30 minutes or less, thereby producing an isothermally treated precursor sample tow,
(ii) assessing if Tₓ¹ and P_{z}¹ are optimal stabilisation conditions for the sample tow by examining the isothermally treated precursor sample tow for absence or presence of evidence of tow burning or tow breakage, and
   whereby:
identifying such evidence indicates that Tₓ¹ and P_{z}¹ are not optimal for the treated precursor sample tow and the isothermally treated precursor sample tow produced is unsuitable to withstand a subsequent carbonisation step required to generate a carbon fibre;
   and whereby:
in absence of such evidence, the method comprises the further step of:
(B): determining a structural conversion index (SCI) associated with the isothermally treated precursor sample tow by
obtaining a Fourier Transform Infrared Spectroscopy (FTIR) spectrum of the isothermally treated precursor sample tow, and
calculating the SCI using the following equation:

$$Conversion index = \frac{0.29 \times Abs ( 1595 )}{Abs ( 2243 ) + 0.29 \times Abs ( 1595 )}$$

wherein,
   Abs(1595) is the absorbance peak intensity at 1595 cm⁻¹ wavenumber which corresponds to C═N functional group, and
   Abs(2243) is the absorbance peak intensity at 2243 cm⁻¹ wavenumber which is associated with C≡N functional group,
      whereby,
determining an SCI of less than 0.5 indicates that the isothermally treated precursor sample tow is not sufficiently thermally stabilised to withstand a subsequent carbonisation treatment step to generate a carbon fibre, or
determining an SCI of from 0.5 to 0.7 indicates that the isothermally treated precursor sample tow is sufficiently stabilised to withstand a subsequent carbonisation treatment to generate a carbon fibre.

It will be understood that the method can be applied to a particular batch of polyacrylonitrile (PAN) based precursor fibres under investigation. Typically, batch to batch variation in polyacrylonitrile (PAN) based precursor fibres means that no one set of ideal parameters are applicable to thermal stabilisation processing in carbon fibre manufacture.

Evidence of tow burning will be understood by the person skilled in the art to mean visual (at least by the naked eye) observation or one or more of the following states: burning, charring, blistering, expansion and/or other forms of degradation of the precursor material compared to its pristine initial state.

Evidence of tow breakage will be understood by the person skilled in the art to mean visual (at least by the naked eye) observation or one or more of the following: breakage, fracturing, splintering, fraying, sloughing, curling, wrinkling and/or other forms of mechanical degradation of the precursor material compared to its pristine initial state.

If the isothermally treated precursor sample shows evidence of tow burning and/or tow breakage after having been subjected to the particular stabilisation conditions of (i) and (ii) above, this indicates that the particular stabilisation conditions applied are not suitable conditions (that is not optimal conditions) so as to ensure that such resultant stabilised treated precursor fibres can safely be subjected to the next carbonisation step to generate a carbon fibre. It is evident that if the resultant sample tow is not sufficient for the subsequent carbonisation step, different stabilisation conditions need to be considered and applied to another sample taken from the particular batch under consideration.

Preferably, wherein on determining an SCI below 0.5, the method further comprises the step of:
repeating steps (A)(i) and (A)(ii) on a new sample tow from the same batch of polyacrylonitrile (PAN) based precursor fibres, whereby repeated step (A)(i) involves isothermally heating the new sample tow at a temperature of Tₓ²>Tₓ¹ and optionally for a treatment time of P_{z}²>P_{z}¹; and
whereby in repeated step (A)(ii), identifying evidence of tow burning and/or tow breakage in the isothermally treated precursor sample tow indicates that Tₓ² and/or P_{z}² are not optimal for the new treated sample tow with respect to subsequent carbonisation,
such that
repeating stepwise steps (A)(i) and (A)(ii) on further sample tows from the batch at successively higher temperatures of Tₓⁿ⁺¹>Tₓⁿ, and optionally for successively longer treatment times of T_{z}ⁿ⁺¹>T_{z}ⁿ⁺¹, where n is 2, 3, 4, 5, 6, etc. is required as necessary until:
no evidence of tow burning and/or tow breakage is found in repeated step (A)(i), and
a structural conversion index selected from the range of from 0.5 to 0.7 is identified in repeated step (A)(ii).

It will be understood that a structural conversion index in the range of from 0.5 to 0.7 indicates that the treated precursor sample is sufficiently stabilised to withstand a subsequent carbonisation treatment step to generate a carbon fibre. The stabilising conditions resulting in no tow breakage or burning and a structural conversion index in the range of from 0.5 to 0.7 can then be utilised in a batch process for producing carbon fibres as defined herein. Likewise, wherein on determining a SCI above 0.7, the method further comprises the step of:
repeating step (A)(i) and step (A)(ii) using a further still sample tow from the batch, whereby repeated step (A)(i) involves isothermally heating the further still sample tow at a temperature of Tₓ²<Tₓ¹ and optionally for a treatment time of P_{z}²<P_{z}¹, and
whereby in repeated step (A)(ii), identifying evidence of tow burning and/or tow breakage in the isothermally treated precursor sample tow indicates that that Tₓ² and/or P_{z}² are not optimal for the further still treated sample tow with respect to subsequent carbonisation,
such that
repeating stepwise steps (A)(i) and (A)(ii) on additional sample tows at successive lower temperatures of Tₓⁿ⁺¹<Tₓⁿ, and optionally for successively shorter treatment times of T₂ⁿ⁺¹<T₂ⁿ⁺¹, where n is 2, 3, 4, 5, 6, etc. is required as necessary until:
no evidence of tow burning and/or tow breakage is found in repeated step (A)(i), and
a structural conversion index selected from the range of from 0.5 to 0.7 is identified in repeated step (A)(ii).

It will be understood that a structural conversion index in the range of from 0.5 to 0.7 indicates that the treated precursor sample is sufficiently stabilised to withstand a subsequent carbonisation treatment step to generate a carbon fibre. The stabilising conditions resulting in no tow breakage or burning and a structural conversion index in the range of from 0.5 to 0.7 can then be utilised in a batch process for producing carbon fibres as defined herein.

In some embodiments, an upper limit of the temperature in the stabilisation step may be selected from: 300° C., 299° C., 298° C., 297° C., 296° C., 295° C., 294° C., 293° C., 292° C., 291° C., 290° C., 289° C., 288° C., 287° C., 286° C., 285° C., 284° C., 283° C., 282° C., 281° C., 280° C., 279° C., 278° C., 277° C., 276° C., 275° C., 274° C., 273° C., 272° C., 271° C., 270° C., 269° C., 268° C., 267° C., 266° C., 265° C., 264° C., 263° C., 262° C., 261° C., 260° C., 259° C., 258° C., 257° C., 256° C., 255° C., 254° C., 253° C., 252° C., 251° C., or 250° C.

Suitably, wherein in step (A)(i) the treatment time (P_{z}¹) of about 30 minutes or less, preferably less than about 15 minutes. Desirably, in step (A)(i) the treatment time (P_{z}¹) is about 24 minutes or about 12 minutes. “About” means ±0.25 minutes.

In some embodiments, an upper limit of the treatment or dwell time in the stabilisation step may be selected from: 29 minutes, 28 minutes, 27 minutes, 26 minutes, 25 minutes, 24 minutes, 23 minutes, 23 minutes, 21 minutes, 20 minutes, 19 minutes, 18 minutes, 17 minutes, 16 minutes, 15 minutes, 14 minutes, 13 minutes, 12 minutes, 11 minutes, 10 minutes, 9 minutes, 8 minutes, 7 minutes, 6 minutes, 5 minutes, 4 minutes, 3 minutes, 2 minutes or 1 minute. Preferably, the structural conversion index selected from the range of from about 0.60 to about 0.65. “About” means ±0.05 minutes.

In some embodiments, in step (A)(i) the sample of precursor fibre tow is tensioned.

In some embodiments, the fibres are tensioned at one or more stages of the described processes a value up to 3500 cN or up to 3000. In some embodiments, the tension may be selected from 25 to 3000 cN, preferably from 50 to 2700 cN. Exemplary suitable tensions for the isothermal stabilisation step range up to 3000 or up to 2000 cN, preferably 200 to 1750 cN. In some embodiments, a tow tension of 200, 300, 400, 500, 600, 700, 800, 900, 1000, 1100, 1200, 1300, 1400, 1500 or 1600 is particularly preferred. Particularly suitable tensions for the isothermal stabilisation step are 200, 1100 and 1600 cN. However, in some embodiments, the isothermally treated precursor fibres are tensioned at a value of at least 3000 cN.

Preferably, step (A)(i) is carried out in a single oven.

Suitably, step (A)(i) is carried out in the presence of air, more preferably oxygen.

Preferably, step (A)(ii) is carried visually and/or microscopically.

The invention further extends to thermally stabilised polyacrylonitrile (PAN) based carbon fibre precursor obtainable by or obtained by the method of the invention which uses the identified optimised parameters for thermal stabilisation.

The invention also relates to use of a thermally stabilised polyacrylonitrile (PAN) based carbon fibre precursor of the invention (which results from thermal stabilisation using parameters identified by the methods described herein) in carbon fibre manufacture.

The invention further extends to a method of manufacturing carbon fibres, comprising the steps of:
subjecting a batch of polyacrylonitrile (PAN) based precursor fibres to stabilisation conditions for that batch of precursor fibres as identified by a method according to the first aspect, thereby generating a batch of isothermally treated precursor fibres;
subjecting the batch of isothermally treated precursor fibres to a carbonisation process to produce carbon fibres.

The initial process may be conveniently carried out in a laboratory oven or the like. It follows that steps can then be applied on a larger scale (e.g., pilot line and/or commercial manufacturing line).

Suitably, the carbonisation process comprises a two step process involving an initial low temperature carbonisation step and a subsequent high temperature carbonisation step.

Suitably, the initial low temperature carbonisation step involves heating the treated precursor fibres to one or more low carbonisation temperatures of between 400° C. to 1000° C., preferably from 425° C. to 900° C., more preferably from 450° C. to 850° C. Suitably, two or more, and preferably at least three temperatures are selected, and the stabilised fibres are treated for a total dwell time are treated for a total dwell time covering all selected temperatures. For example, the initial low temperature carbonisation step may involve application of three zones of temperature from these ranges, for example, 450° C.-650° C.-850° C., for example, for a total dwell time ranging from about 3 minutes to about 8 minutes. “About” means ±0.05 minutes, that is ±3 seconds.

Desirably, the initial low temperature carbonisation step involves heating in a suitable furnace at one or more of the required low carbonisation temperatures for a total dwell time ranging from 3 minutes to about 8 minutes. Particularly preferred dwell times range from about 3.6 to about 7.2 minutes. In some embodiments, dwell times of about 3.6, about 5.4, or about 7.2 minutes in the low temperature furnace are particularly preferred. About” means ±0.05 minutes, that is ±3 seconds.

Desirably, the subsequent high temperature carbonisation step involves heating the isothermally treated precursor fibres to temperature of at least 1000° C. based on the final requirement of carbon fibre properties. Desirably, the subsequent high temperature carbonisation step involves heating the isothermally treated precursor fibres to temperature of from 1000° C. to 1600° C., preferably from 1100° C. to 1500° C., more preferably from 1250° C. to 1450° C. Suitably, at least two temperatures are selected and the stabilised fibres are treated for a total dwell time covering all selected temperatures.

Desirably, the high temperature carbonisation step involves heating in a suitable furnace at one or more of the required high carbonisation temperatures, for example, for a total dwell time ranging from 1 minutes to about 6 minutes. Particularly preferred dwell times range from 2 to 5 minutes. In some embodiments, dwell times of about 2.4, about 3.6, and about 4.8 minutes in the high temperature furnace are particularly preferred. About” means ±0.05 minutes, that is ±3 seconds.

In some preferred embodiments, the high temperature carbonisation step may involve application of two zones of temperature from these ranges, for example, 1200° C.-1400° C. or 1200° C.-1450° C. for a total dwell time ranging from about 1 to about 5 minutes. About” means ±0.05 minutes, that is ±3 seconds.

In some embodiments, the fibres are tensioned at one or more stages of the described processes a value up to 3500 cN. In some embodiments, the tension may be selected from 25 to 3000 cN, preferably from 50 to 2700 cN.

Exemplary suitable tensions for the stage 1 low temperature carbonisation step preferably range up to 1500 cN, preferably 50 to 1300 cN. Particularly suitable tensions for the isothermal stabilisation step are 55, 60, 350, 550 and 1200 cN.

Exemplary suitable tensions for the stage 2 high temperature carbonisation step preferably range up to 3000 cN, preferably 75 to 2750 cN. Particularly suitable tensions for the isothermal stabilisation step are 280, 2300 and 2700 cN.

Preferably, the isothermally treated precursor fibres are tensioned, particularly in methods carried on a larger scale (e.g., pilot line and/or commercial manufacturing line).

One aspect of the invention focuses on developing a rapid manufacturing method for carbon fibres from a PAN precursor, as a result of the method of the present invention, the manufacturing method of the invention involves a reduced number of ovens and/or reduced dwell time in stabilisation ovens result in significant cost savings and/or reduced operations footprint.

The invention has been developed as a result of investigations into the thermal tolerance of a variety of PAN based precursor fibres in addition to the structural conversion response of a PAN based precursor with respect to applied process parameters, particularly temperature and more particularly the combination of temperature and exposure time in a stabilisation/oxidation step of a typical carbon fibre manufacturing process.

It has been determined that by applying the methods of the invention as described herein, the significant efficiencies and cost savings can be made using improved carbon manufacturing methods described herein compared to typical carbon fibre manufacturing processes. For example, oven investment costs in a newly designed carbon fibre production plant can be reduced up to a factor of 1/X, where X is the number of ovens used in a conventional process (4 to 8 typically). Additionally, as the methods described herein can be applied to existing equipment, utilization of the described methods can lead to very significant increases in production speed and therefore significantly increases the productivity of the whole plant.

Unlike conventional methods of carbon fibre manufacturing, the improved method of the invention based on the improved thermal stabilisation step described herein requires only one oven to complete the stabilisation process in as little as 12 minutes in some cases. The efficiencies result from use of well-balanced process parameters during the stabilisation stage to rapidly attain the required structural conversion of PAN into stabilised (oxidized) PAN prior to the carbonisation process step.

Depending on the mode of implementation of this method, it is possible to either significantly reduce the capital investment or increase production capacity or both and all cases reduce the overall production cost of carbon fibres.

### Description of Preferred Embodiments

Traditionally, due to the exothermic reactions occurring during PAN based precursor fibre stabilisation, to prevent fibre tow breakage or burning occurring during stabilisation, it has been necessary to subject the precursor fibres to slow and controlled thermal stabilisation in the form of an increasing temperature gradient which is applied through exposure of precursor fibres to multiple temperature steps at temperatures between 200° C. and 300° C.

Surprisingly, the inventors have now realized that rapid thermal stabilisation resulting in sufficient structural conversion of the PAN based precursor fibres to the desired polymeric ladder type structure can be achieved by exposing the PAN based precursor fibres to an isothermal heat process which can conveniently be achieved in a single zone of stabilisation. Unexpectedly, the rapid structural conversion of the PAN based precursor fibres is achieved without burning off or damaging the fibre tows. The rapid thermal stabilisation is achieved by applying a tailored heating regime to a particular batch or form of PAN based precursor fibres. The tailored heat stabilisation regime used is particular to any particular precursor used and determined prior to heat treatment by developing an understanding of the thermal tolerance of a particular precursor of interest, along with the inherent capacity of that fibre to undergo the required structural conversion before carbonisation.

Advantageously, the rapid stabilisation strategy involves the application of a maximum tolerable heat for any given fibre precursor for a given dwell time of less than about 30 minutes. “About” means ±0.05 minutes.

Unexpectedly, this strategy has been found to rapidly promote thermal stabilisation (oxidation) of precursor fibres to an optimal degree that allows the stabilised (oxidised) fibres to withstand the subsequent very high temperatures required for conversion of stabilised precursor fibres to carbon fibre through a carbonisation process.

The finding that stabilisation can be affected by rapid application of the maximum possible heat possible without precursor degradation runs contrary to all traditional methods and understanding of PAN based precursor fibres stabilisation methods.

### EXPERIMENTAL AND RESULTS

The thermal tolerance of any batch or variety of PAN precursor fibres can be established by exposing individual sample tows of precursor fibres under no tension, for example in a laboratory oven, to various isothermal temperatures, for a dwell time corresponding to that which a fibre commonly experiences in one stabilisation oven at a certain speed (e.g., approximately 24 minutes oven dwell time in a continuous line). Thereafter, the precursor is examined visually to determine if any tow breakage or burning of tow has occurred due to exposure to the particular test conditions. It has been found that if non-tensioned fibre precursors pass the applicable test, application of tension to the fibres does not negatively affect the outcome after application of the same parameters.

### Example 1—Outline of Procedure

A sample pristine precursor fibre tow is treated to a first set of stabilisation conditions involving heating isothermally at ˜200° C. for 24 minutes and subsequently visually examined for fibre burning or tow breakage. If there are no indications of fibre burning or tow breakage, in a next step another sample of pristine precursor tow from the same precursor batch will be isothermally treated for 24 min at higher temperature than applied in the first step. Further observations will be made as to whether for that fibre, fibre burning or tow breakage occurred under the second set of stabilisation conditions. This procedure will be continued on successive samples of the tows from the same precursor batch under investigation until the fibre tow is determined to burn at a particular temperature. The temperature at which burning occurs is defined as the material-specific upper thermal tolerance limit.

After attaining the maximum temperature at which a fresh sample precursor fibre can be exposed to without burning, it is possible to set the initial zone temperature in a continuous manufacturing line.

Based on the assessments performed on the fibre's structural conversion by FTIR, the temperature requirements of the next carbonisation stage can be decided. Once the fibre is sufficiently/optimally thermally stabilised, it can be carbonised first in low-temperature at various temperature steps ranging from 350 to 1000° C. and afterwards in a high-temperature furnaces at various temperature steps ranging from 900 to 2500° C. or greater if desired to produce carbon fibres.

The inventors have found that the rapid stabilisation strategy should apply maximum heat at the precursors upper thermal limit for a shorter time period than existing methods, to rapidly promote thermal stabilisation of fibre to a degree such that is the stabilised precursor can withstand the temperatures to be applied in the following carbonisation process.

### Example 2—Type 1 Precursor

For instance, in the current work, a Type-I precursor from Company A was used to assess the method. Interestingly, the thermal tolerance of sample tows from precursor was noticed to be very high where no signs of burning and tow breakage were observed even at the temperatures in the order of ˜280° C. in the lab oven. This observation directed the use of only two ovens which are maintained at ˜270° C. and ˜295° C. for thermal stabilisation process for a total dwell time of ˜24 minutes at an average tension of ˜ 1950 cN as an initial trial. In this case, the dwell time in each over is 12 minutes at the isothermal temperature. It will be understood that any desired tension can be applied by varying the speed of the input and output roller speeds of an oven in a process line.

However, after the thus so stabilised fibre was carbonised (see conditions in Table 1), the resultant carbon fibre produced were fragile and low in tensile properties. This is believed to be due to the Type-I precursor fibres being either over stabilised or under stabilised preventing proper and/or complete conversion into carbon fibre. Overall, the inventors believe that the very high temperature used in the first oven means that the structural conversion in the fibre precursor was rapid and fibres are believed to have been over stabilised.

Thus, the process was repeated for additional sample tows with a reduction in the first oven temperature to ˜265° C., and only one oven was used instead of two ovens. The precursor fibre sample tows were subjected to the thermally stabilisation conditions for various times ranging from ˜12 to 24 minutes.

Interestingly, even with a very short processing time of 12 minutes (compared to traditional 50-90 minute stabilisation process, depending on the line speed), the properties of the final carbonised carbon fibres improved significantly (see conditions used and results in Table 1).

### Example 3-General Exemplary Steps to Establish the Rapid Stabilisation Method

Samples of pristine precursor fibre tows were isothermally treated at a temperature selected in the range of about 200° C. to about 300° C. (e.g., approximately 235° C. ±1%) for a period of about 30 minutes or less (e.g., (i) about 24 min or less, or (ii) about 12 min or less if period (i) is not optimal) (depending on precursor fibre being considered). “About” means ±0.05 minutes.

After the thermal stabilisation treatment step, the treated precursor fibres of the tows were subsequently examined for evidence of fibre burning or tow breakage, as well as the degree of structural conversion after thermal treatment for fibres in each sample tow.

If there are no indications of fibre burning upon examination, this indicates that the precursor has been thermally stabilised. The samples are then subjected to further analysis to consider the degree of structural conversion towards the desired polymeric ladder structure in respect of the heat treated fibres. The degree of structural conversion is assessed by calculating a structural conversion index (Equation 1) using at least one sample spectrum obtained from Fourier Transform Infrared Spectroscopy (FTIR) studies carried out on the isothermally treated fibres. For example, FTIR studies herein are conducted in ATR mode using Bruker Lumos FTIR equipped with a Germanium crystal. FTIR spectra of samples is collected between 600 to 4000 cm⁻¹ wavenumbers at a resolution of 4 cm⁻¹. Each spectral data is an average of 64 co-added scans and the structural conversion data for each sample is an average of data obtained from three different locations on the fibre tow sample.

In general, it has been found that for a PAN based precursor fibre thermally stabilised in air, a structural conversion index of between 0.5 to 0.7, more preferably 0.60 to 0.65, is associated with stabilised precursor fibres which are suitable for subjecting to a subsequent carbonisation process required to convert the stabilised precursor to carbon fibre. The inventors have found that if the examined structural conversion index falls in the proposed range, the treated precursor fibres can be safely carbonized in the next step to produce carbon fibres.

The structural conversion index (also known as extent of reaction) is calculated in accordance with the following formula:

$$Extent of Reaction ( E O R ) = \frac{0.29 \times Abs ( 1595 )}{Abs ( 2243 ) + 0.29 \times Abs ( 1595 )}$$

where, “Abs(1595)” is the FTIR absorbance peak intensity at 1595 cm⁻¹ wavenumber which is associated with the C═N functional group, and “Abs(2243)” is the FTIR absorbance peak intensity at 2243 cm⁻¹ wavenumber which is associated with the C≡N functional group.

Where the structural conversion index falls outside the proposed range, this is indicative that the treated precursor fibres are not suitable for carbonisation and that the isothermal treatment conditions applied are not optimally for the particular precursor in question. In other words, the isothermal treatment conditions have been detrimental to the PAN based precursor fibres.

Where a non-compliant structural conversion index is observed, the isothermal treatment step is repeated using a fresh sample of the pristine precursor tow from the batch under investigation. For example, the new sample is isothermally treated for (i) 24 min or (ii) 12 min or less, at a slightly higher temperature than applied in the initial isothermal treatment step (e.g., about 240° C.). This is followed by examination of the fresh PAN based precursor fibres' structural and physical condition and degree of structural transformations as described above. In some embodiments, the slightly higher temperature may be 5° C., 4° C., 3° C., 2° C., 1° C., or 0.5° C. higher than the immediately previous temperature trialled. The magnitude of the higher temperature difference compared to the previously applied temperature depends on how close the result to the desired SCI. For an SCI result that is within 20% of the upper or lower end of the SCI range, a larger magnitude of higher temperature change can be applied that would be required for a case where desired SCI is within 1% of the less upper or lower end of the SCI range, whereby a smaller increase in temperature would be applied.

This procedure is continued until conditions that result in isothermally treated PAN based precursor fibres which achieve the required structural conversion without burning or breaking in the stabilisation oven are identified. If sufficient structural conversion does not occur (as demonstrated by a non-compliant structural conversion index) and the fibre bums at the given temperature, the procedure can be re-applied at the same temperature but using a shorter less dwell time than previously applied.

At the end of this exercise, it is possible to identify the optimal temperature and optionally dwell time at which any given PAN based precursor fibres can be exposed to, in the initial zone of stabilisation stage, to achieve the required degree of structural conversion that allows those treated fibres to proceed to the subsequent carbonisation step. In some embodiments, preferred starting dwell times are 24 minutes. Shorter dwell times are only applied when no evidence of burning or breakage or a compliant SCI using the 24 minute dwell time. In some cases, the dwell time may be as low as 12 minutes.

Commercial PAN based precursor fibres available on the market. Other proprietary PAN based precursor fibres are developed for in house only use. However, with each precursor having a different chemical composition and properties, they each demonstrate different thermal behaviour under the same conditions. Therefore, the maximum temperature and/or dwell time any given PAN based precursor fibres can be exposed to in the isothermal stabilisation step can vary greatly between precursors and should be defined by developing an understanding the thermal tolerance of the chosen PAN precursor using the method described herein. As the thermal tolerance is explored on the basis of application of the screening method of the invention which screens for temperature and dwell time tolerance for any particular fibre precursor, the precise compositions per se of the precursors used is not a factor in the determination of the optimal stabilisation conditions for a particular precursor.

The improved PAN based precursor fibres isothermal stabilisation methods as described herein have been verified using four different PAN based precursor fibres, two of which are commercially available PAN based precursor fibres and two which are inhouse developed PAN based precursor fibres. The details of two inhouse precursor fibre compositions are set out in the table provided in the last 2 rows.

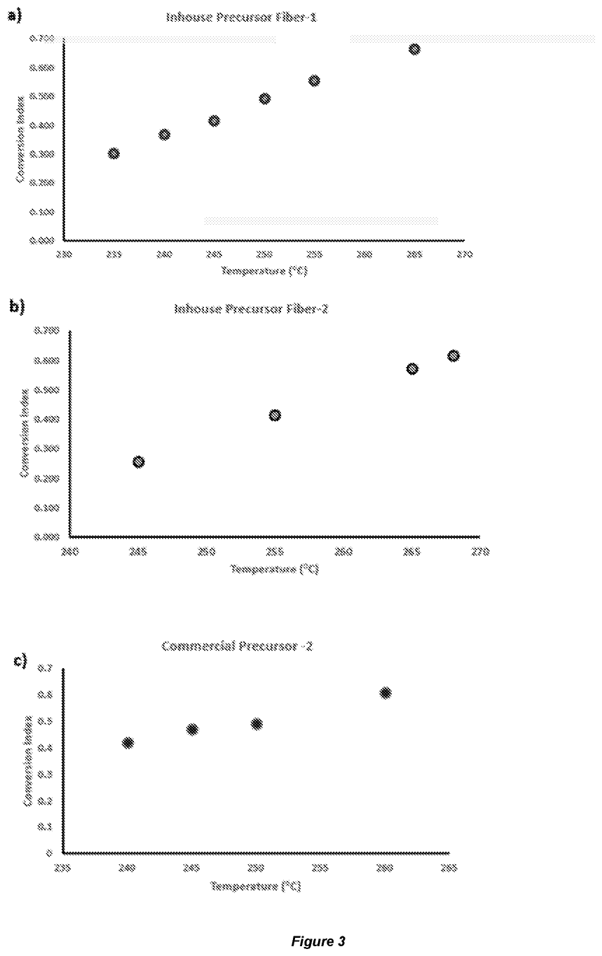

As an example, the correlation between stabilisation temperature and the structural conversion index is shown in FIG. 3.

### Results

As can be seen in Table 1, all the tested PAN based fibre precursors tested were found to attain the required structural conversion index when isothermally treated under optimal treatment conditions as identified using the methods described herein.

In general, the optimal conditions shown in Table 1 for the tested PAN based fibre precursors involved an isothermal stabilisation temperature of between about 260° C. and about 270° C., (“about” means ±1%) for a dwell time of either about 12 minutes or about 24 minutes (“about” means ±0.05 minutes) (depending on the type of precursor) applied in a single stabilisation stage.

After attaining the optimal stabilisation conditions for fibres in sample tows each of the four precursors using the proposed rapid thermal stabilisation protocol described herein, the thermally stabilised fibres of each precursor type were subsequently carbonized and carbon fibres under the conditions disclosed in the table were successfully produced. The properties of the resultant carbon fibres are shown in Table 1.

While carbon fibres were successfully produced in every case, of the precursors subjected to the present methods, the mechanical properties of carbon fibres produced from commercial-1 precursor showed significantly higher properties compared to other carbon fibres.

It should be noted that the properties obtained for a number of the carbon fibres manufactured from this study are almost close to T300 commercial fibres. The properties of the preferred carbon fibres are more than the required properties for their use in automobiles.

The Commercial Precursor 1 was initially stabilised in air atmosphere at 265° C. for 12 min under ˜1600 cN tension to ensure that the fibre is thermally stable enough to with stand high temperatures during a subsequent carbonisation step. The structural conversion index of the treated precursor fibres was assessed using a FTIR technique was found to be 0.55.

Subsequently, the stabilised fibres are processed under a first carbonisation stage at a tension of ˜ 550 cN for a total dwell time of ˜3.6 min in low temperature furnace which has three temperature zones, and each zone was maintained at 450, 650 and 850° C.

Later these fibres are further carbonised in high temperature furnace which has two temperature zones, which were maintained at 1200 and 1400° C. The total dwell time and tension applied in this further carbonisation stage are 2.4 min and ˜2300° C., respectively.

The described study starting from Commercial precursor 1 resulted in desirable carbon fibres with tensile strength of 3.68 GPa, tensile modulus of 223.7 GPa and % elongation of 1.77.

TABLE 1
Process specifications and properties of carbon fibres produced from various
precursor fibres using rapid thermal stabilisation on research line system.

| | | | | | | | | | | | | Properties of Produced | | | |
|---|---|---|---|---|---|---|---|---|---|---|---|---|---|---|---|
| | | | Isothermal | | | Low Temperature | | | High Temperature | | | Carbon Fibres | | | |
| | | | Stabilisation | | | Carbonisation Process | | | Carbonisation Process | | | | Ten- | | |
| | | | Process | | | Specifications in | | | Specifications in | | | Ten- | sile | | |
| Pre- | | | Specifications | | | Low Temp Furnace | | | High Temp Furnace | | | sile | Modu- | | |
| cur- | | | Temp. | Time | Ten. | Temp. | Time | Ten. | Temp. | Time | Ten. | Stren. | lus | % | EOR/ |
| sor | Composition | FC | (° C.) | (min) | (cN) | (° C.) | (min) | (cN) | (° C.) | (min) | (cN) | (GPa) | (GPa) | Elong. | SCI |
| Com- | Not disclosed | 12k | 265 | 12 | ~1600 | 450-650-850 | 3.6 | ~1200 | 1200-1450 | 2.4 | ~2300 | 3.38 | 235 | 1.57 | 0.57 |
| 1 | Not disclosed | 12k | 265 | 18 | ~1600 | 450-650-850 | 5.4 | ~1200 | 1200-1450 | 3.6 | ~2300 | 3.49 | 241 | 1.58 | 0.62 |
| | Not disclosed | 12k | 265 | 24 | ~1600 | 450-650-850 | 7.2 | ~1200 | 1200-1450 | 4.8 | ~2300 | 3.25 | 240.7 | 1.47 | 0.66 |
| | Not disclosed | 12k | 265 | 12 | ~1600 | 450-650-850 | 3.6 | ~550 | 1200-1400 | 2.4 | ~2300 | 3.68 | 223.4 | 1.77 | 0.55 |
| | Not disclosed | 12k | 265 | 12 | ~1600 | 450-650-850 | 3.6 | ~550 | 1200-1400 | 2.4 | ~2700 | 3.53 | 232 | 1.65 | 0.55 |
| | Not disclosed | 12k | 265 | 18 | ~1600 | 450-650-850 | 5.4 | ~550 | 1200-1400 | 3.6 | ~2300 | 3.38 | 234.7 | 1.56 | 0.65 |
| | Not disclosed | 12k | 265 | 18 | ~1600 | 450-650-850 | 5.4 | ~550 | 1200-1400 | 3.6 | ~2700 | 3.24 | 234.4 | 1.49 | 0.65 |
| | Not disclosed | 12k | 267 | 12 | ~1600 | 450-650-850 | 3.6 | ~550 | 1200-1400 | 2.4 | ~2300 | 3.50 | 220.3 | 1.72 | 0.59 |
| | Not disclosed | 12k | 267 | 12 | ~1600 | 450-650-850 | 3.6 | ~550 | 1200-1400 | 2.4 | ~2700 | 3.40 | 229.4 | 1.61 | 0.59 |
| | Not disclosed | 12k | 267 | 18 | ~1600 | 450-650-850 | 5.4 | ~550 | 1200-1400 | 3.6 | ~2300 | 3.37 | 225 | 1.61 | 0.65 |
| | Not disclosed | 12k | 267 | 18 | ~1600 | 450-650-850 | 5.4 | ~550 | 1200-1400 | 3.6 | ~2700 | 3.30 | 227.3 | 1.56 | 0.65 |
| | Not disclosed | 12k | 263 | 12 | ~1600 | 450-650-850 | 3.6 | ~550 | 1200-1400 | 2.4 | ~2300 | 3.57 | 227.2 | 1.72 | 0.51 |
| Com- | Not disclosed | 12k | 260 | 12 | ~1100 | 450-650-850 | 3.6 | ~350 | 1200-1400 | 2.4 | ~1000 | 2.10 | 188.16 | 1.21 | 0.62 |
| 2 | | | | | | | | | | | | | | | |
| IH-1 | 96/3/1 wt % | 0.5k | 265 | 24 | ~200 | 450-650-850 | 7.2 | ~55 | 1200-1400 | 4.8 | ~280 | 2.06 | 190.2 | 1.17 | 0.66 |
| | (AN/MA/IA) | | | | | | | | | | | | | | |
| IH-2 | 96.7/3/ | 0.5k | 268 | 24 | ~200 | 450-650-850 | 7.2 | ~60 | 1200-1400 | 4.8 | ~100 | 1.29 | 178 | 0.76 | 0.62 |
| | 0.3 wt % | | | | | | | | | | | | | | |
| | (AN/MA/IA) | | | | | | | | | | | | | | |

*% elong = % elongation at break while conducting the tensile loading procedure. The data shown is commonly achieved for carbon fibres.
*stabilisation reactions occur at a slower rate in fibres under tension compared to fibers under no tension.
* where fiber breakage or burning occurs during stabilisation, it is not possible to carbonise and produce carbon fibres.
*three zones in the LT furnace, whereby each zone is maintained at indicated temperatures. The dwell time represents the overall time spent by fiber tow in the LT furnace.
Fc = filament count; AN = acrylonitrile, MA = methyl acrylate and IT = itaconic acid; Com = composition; Ten = tension; Elong = elongation.

1-21. (canceled)

22. A method of manufacturing carbon fibres, comprising the steps of:
subjecting a batch of polyacrylonitrile (PAN) based precursor fibres to precursor stabilisation conditions for that batch of precursor fibres identified as optimal for that batch by applying a method of identifying stabilisation conditions for producing a thermally stabilised polyacrylonitrile (PAN) based carbon fibre precursor from any batch of precursor for use in a carbon fibre manufacturing to a sample tow of the precursor fibres from the batch, thereby generating a batch of isothermally treated precursor fibres which presents as absent of evidence of tow burning or tow breakage, and having a structural conversion index selected from the range of from 0.60 to 0.65;
subjecting the batch of isothermally treated precursor fibres to a carbonisation process to produce carbon fibres,
wherein the method of identifying stabilisation conditions for producing a thermally stabilised polyacrylonitrile (PAN) based carbon fibre precursor from any batch of precursor for use in a carbon fibre manufacturing process, the method comprising:
(A): thermally stabilising a sample tow from a particular batch of polyacrylonitrile (PAN) based precursor fibres under investigation by:
(i) subjecting the sample tow to a first set of stabilisation conditions by applying a single isothermal heating treatment to the sample tow at a first temperature (Tₓ¹) selected from 200° C. to 300° C. for a treatment time (P_{z}¹) of 30 minutes or less, thereby producing an isothermally treated precursor sample tow,
(ii) assessing if Tₓ¹ and P_{z}¹ are optimal stabilisation conditions for the sample tow by examining the isothermally treated precursor sample tow for absence or presence of evidence of tow burning or tow breakage, and
whereby:
identifying of such evidence indicates that Tₓ¹ and P_{z}¹ are not optimal for the treated precursor sample tow and the isothermally treated precursor sample tow produced is unsuitable to withstand a subsequent carbonisation step required to generate a carbon fibre;
and whereby:
in absence of such evidence, the method comprises the further step of:
(B): determining a structural conversion index (SCI) associated with the isothermally treated precursor sample tow by
obtaining a Fourier Transform Infrared Spectroscopy (FTIR) spectrum of the isothermally treated precursor sample tow, and
calculating the SCI using the following equation:
$$Extent of Reaction ( E O R ) = \frac{0.29 \times Abs ( 1595 )}{Abs ( 2243 ) + 0.29 \times Abs ( 1595 )}$$
wherein,
Abs(1595) is the absorbance peak intensity at 1595 cm⁻¹ wavenumber which corresponds to C═N functional group, and
Abs(2243) is the absorbance peak intensity at 2243 cm⁻¹ wavenumber which is associated with C≡N functional group,
whereby,
determining an SCI of less than 0.5 indicates that the isothermally treated precursor sample tow is not sufficiently thermally stabilised to withstand a subsequent carbonisation treatment step to generate a carbon fibre,
or
determining an SCI of from 0.5 to 0.7 indicates that the isothermally treated precursor sample tow is sufficiently stabilised to withstand a subsequent carbonisation treatment to generate a carbon fibre.

23. The method of claim 22, wherein on determining an SCI below 0.5, the method further comprises the step of:
repeating steps (A)(i) and (A)(ii) on a new sample tow from the same batch of polyacrylonitrile (PAN) based precursor fibres, whereby repeated step (A)(i) involves isothermally heating the new sample tow at a temperature of Tₓ²>Tₓ¹ and optionally for a treatment time of P_{z}²>P_{z}¹; and
whereby in repeated step (A)(ii), identifying evidence of tow burning and/or tow breakage in the isothermally treated precursor sample tow indicates that Tₓ² and/or P_{z}² are not optimal for the new treated sample tow with respect to subsequent carbonisation,
such that
repeating stepwise steps (A)(i) and (A)(ii) on further sample tows from the batch at successively higher temperatures of Tₓⁿ⁺¹<Tₓⁿ, and optionally for successively longer treatment times of T₂ⁿ⁺¹<T₂ⁿ⁺¹, where n is 2, 3, 4, 5, 6, etc. is required as necessary until:
no evidence of tow burning and/or tow breakage is found in repeated step (A)(i), and
a structural conversion index selected from the range of from 0.5 to 0.7 is identified in repeated step (A)(ii).

24. The method according to claim 22, wherein on determining a SCI above 0.7, the method further comprises the step of:
repeating step (A)(i) and step (A)(ii) using a further still sample tow from the batch, whereby repeated step (A)(i) involves isothermally heating the further still sample tow at a temperature of Tₓ²<Tₓ¹ and optionally for a treatment time of Pₓ²<P_{z}¹,and
whereby in repeated step (A)(ii), identifying evidence of tow burning and/or tow breakage in the isothermally treated precursor sample tow indicates that that Tₓ² and/or P_{z}² are not optimal for the further still treated sample tow with respect to subsequent carbonisation,
such that
repeating stepwise steps (A)(i) and (A)(ii) on additional sample tows at successive lower temperatures of Tₓⁿ⁺¹<Tₓⁿ, and optionally for successively shorter treatment times of T₂ⁿ⁺¹<T₂ⁿ⁺¹, where n is 2, 3, 4, 5, 6, etc. is required as necessary until:
no evidence of tow burning and/or tow breakage is found in repeated step (A)(i), and
a structural conversion index selected from the range of from 0.5 to 0.7 is identified in repeated step (A)(ii).

25. The method according to claim 22, wherein in step (i) the treatment time (P_{z}¹) of less than 25 minutes.

26. The method according to claim 22, wherein in step (i) the treatment time (P_{z}¹) is 24 minutes or 12 minutes.

27. The method according to claim 22, wherein the structural conversion index selected from the range of from 0.60 to 0.65.

28. The method according to claim 22, wherein in step (i) the sample of precursor fibre tow is tensioned.

29. The method according to claim 22, wherein step (i) is carried out in a single oven.

30. The method according to claim 22, wherein step (i) is carried out in the presence of air.

31. The method according to claim 22, wherein step (ii) is carried out visually and/or microscopically.

32. The method of claim 22, where carbonisation process comprises a two-step process involving an initial low temperature carbonisation step and a subsequent high temperature carbonisation step.

33. The method of claim 32, wherein the initial low temperature carbonisation step involves heating the isothermally treated precursor fibres to temperature of between 350 to 1000° C.

34. The method of claim 32, wherein the subsequent high temperature carbonisation step involves heating the isothermally treated precursor fibres to temperature of between 900 to 2500° C.

35. The method of claim 32, wherein the isothermally treated precursor fibres are tensioned.

36. The method of claim 35, wherein the isothermally treated precursor fibres are tensioned at a value up to 3000 cN or more than 3000 cN.
